(19) United States
(12) Patent Application Publication
(10) Pub. No.: US 2024/0327740 A1
(43) Pub. Date: Oct. 3, 2024

(54) DIESEL FUEL COMPOSITION AND A METHOD FOR PRODUCING A DIESEL FUEL COMPOSITION

(71) Applicant: Neste Oyj, Espoo (FI)

(72) Inventors: Ulla KIISKI, Porvoo (FI); Markku KURONEN, Porvoo (FI); Jenni NORTIO, Porvoo (FI)

(73) Assignee: Neste Oyj, Espoo (FI)

(21) Appl. No.: 18/743,872

(22) Filed: Jun. 14, 2024

Related U.S. Application Data
(63) Continuation of application No. 18/051,164, filed on Oct. 31, 2022, now Pat. No. 12,037,556.
Application No. 18/051,164 is a continuation of application No. 16/326,517, filed on Feb. 19, 2019, now Pat. No. 11,485,924.

(30) Foreign Application Priority Data
Aug. 26, 2016 (FI) 20165635

(51) Int. Cl. C10L 10/14; C10G 3/00; C10G 45/58; C10G 65/04; C10L 1/08; C10L 1/23; C10L 10/12

(52) U.S. Cl. CPC C10L 10/14; C10G 3/42; C10G 3/50; C10G 45/58; C10G 65/043; C10L 1/08; C10L 1/231; C10L 10/12; C10G 2300/1014; C10G 2300/307; C10G 2300/70; C10G 2400/04; C10L 2200/0469; C10L 2270/026; Y02E 50/10; Y02P 30/20

(57) ABSTRACT

Disclosed herein are methods for manufacturing and using a diesel fuel composition comprising a cetane number improver, a fossil fuel component, and a hydrotreated renewable fuel component manufactured by hydrotreating and isomerising renewable raw material.

### PRIORITY DATA

This patent application is a continuation application of U.S. patent application Ser. No. 18/051,164 filed on Oct. 31, 2022, which is a continuation application of U.S. patent application Ser. No. 16/326,517, filed on Feb. 19, 2019, which is a U.S. National Stage application of PCT/FI2017/050597 filed on Aug. 25, 2017, which claims priority to Finnish Patent Application No. FI20165635 filed on Aug. 26, 2016, each of which is hereby incorporated by reference herein.

### FIELD

The present disclosure is related to the field of renewable fuels, and to methods for making them.

### BACKGROUND

Cetane number describes the compression ignition behaviour of a diesel fuel. Higher cetane levels enable faster ignition in a diesel engine. Cetane number is one requirement in EN590:2013 (5.5.2) and ASTM D975 2017 diesel fuel standards. Requirement in EN 590:2013 (5.5.2) diesel is minimum 51 and in ASTM D975 2017 40, correspondingly. In diesel fuels cetane number targets can be reached either by refining, by blending, or by adding a cetane number improver, such as 2-ethyl hexyl nitrate (2-EHN). However, high 2-EHN dosing causes unpleasant smell to diesel fuel. There are also indications that 2-EHN effects to diesel NOx-emissions negatively and additionally according to EN590:2013 (5.5.2) cetane improver may cause increase of carbon residue.

Thus, there is a need to provide fuel compositions with high cetane number while reducing harmful effects linked to cetane number improvers.

EP1956070 discloses a method for producing a gas oil composition. The resulting product requires at least 500 ppm of gas-oil specific cetane number improver to obtain satisfactory cetane number.

US2008033220 discloses increasing cetane number of GTL, a Fischer-Tropsch derived fuel.

### SUMMARY

According to the first aspect of the disclosure is provided a method of manufacturing a diesel fuel composition comprising
a. A hydrotreatment step comprising catalytically hydrotreating renewable raw material comprising fatty acids, triglycerides, fatty acid esters, or combinations thereof into n-paraffins;
b. An isomerising step comprising catalytically isomerising the n-paraffins into branched chain paraffins to obtain a hydrotreated renewable fuel component; and
c. adding a cetane number improver;
wherein the step b. is carried out in the absence of the hydrotreating catalyst(s) used in the step a.

According to the second aspect of the disclosure is provided a diesel fuel composition comprising a hydrotreated renewable fuel component and a cetane number improver.

According to the third aspect of the disclosure is provided a use of the diesel fuel composition of the second aspect for increasing cetane number and improving cold properties of a diesel fuel.

According to the fourth aspect of the disclosure is provided a diesel fuel composition comprising: a. the diesel fuel composition of the second aspect; and b. a fossil fuel component.

According to another aspect of the disclosure there is provided a further diesel fuel composition comprising:
a. a hydrotreated renewable fuel component;
b. a fossil fuel component; and
c. a cetane number improver.

According to another aspect of the disclosure there is provided a method for making a further diesel fuel composition comprising mixing:
a. a hydrotreated renewable fuel component;
b. a fossil fuel component; and
c. a cetane number improver.

According to another aspect is provided method of improving cetane number of a fossil fuel composition comprising adding to the fuel composition
a. a hydrotreated renewable fuel component; and
b. a cetane number improver.

Herein disclosed is an exemplary diesel fuel composition comprising:
a hydrotreated renewable fuel component and a cetane number improver, wherein the hydrotreated renewable fuel component contains at least 70 wt-% C₁₅-C₁₈ paraffins and has an i-paraffin/n-paraffin ratio of at least 2.2 w/w; and
a fossil fuel component; wherein
the hydrotreated renewable fuel component constitutes 5-90 vol-% of the diesel fuel composition; and
the cetane number improver is 2-ethylhexyl nitrate (2-EHN), and the amount of 2-EHN is in a range of 100-1000 mg/kg in the diesel fuel composition.

Also described herein is a method for producing a diesel fuel composition comprising: mixing a hydrotreated renewable fuel component, a cetane number improver, and a fossil fuel component, wherein:
the hydrotreated renewable fuel component comprises at least 70 wt-% C₁₅-C₁₈ paraffins and has an i-paraffin/n-paraffin ratio of at least 2.2 w/w; and
the hydrotreated renewable fuel component constitutes 5-90 vol-% of the diesel fuel composition;
the cetane number improver is 2-ethylhexyl nitrate (2-EHN); and
the amount of 2-EHN is in the range of 100-1000 mg/kg in the diesel fuel composition.

Also disclosed is an exemplary method for improving cetane number in a diesel fuel composition, comprising:
mixing a hydrotreated renewable fuel component, a cetane number improver, and a fossil fuel component, wherein:
   the hydrotreated renewable fuel component comprises at least 70 wt-% C₁₅-C₁₈ paraffins and has an i-paraffin/n-paraffin ratio of at least 2.2 w/w; and
   the hydrotreated renewable fuel component constitutes 5-90 vol-% of the diesel fuel composition;
   the cetane number improver is 2-ethylhexyl nitrate (2-EHN); and
   the amount of 2-EHN is in the range of 100-1000 mg/kg in the diesel fuel composition.

An advantage achieved by the disclosed methods and diesel fuel compositions is efficient increase of cetane number in fuel blends and/or fuel compositions comprising the present diesel fuel composition, in particular in fuel blends for diesel engines. As evidenced by Examples, the cetane number of diesel fuel compositions could be increased by including in it the present diesel fuel composition.

Another advantage achieved by the disclosed methods and diesel fuel compositions is that a low amount of a cetane number improver need to be used in fuel blends to achieve a desired cetane number, such as a cetane number required by a diesel fuel standard. FIG. 2 shows results of an Example where 2-EHN was used as a cetane number improver: a dose of 250 mg/kg resulted into a greater increase of the cetane number in a blend comprising hydrotreated renewable fuel component, compared to a GTL component. Thus, by following the present disclosure a lower amount of the cetane number improver can be used to increase the cetane number to a desired value, which helps to prevent or diminish harmful effects of cetane number improvers, such as 2-EHN. In particular NOx emission increase caused by larger amounts of 2-EHN can be avoided.

Another advantage of the disclosed methods and diesel fuel compositions is that a fuel composition can be obtained which has simultaneously both a good cetane number and also good cold properties. By following the present disclosure it is possible to obtain e.g. diesel fuel blends comprising fossil fuel and having said characteristics. Such diesel fuel blends are particularly good for use in cold climate.

Another advantage of the disclosed methods is that as step b. is carried out in the absence of the catalyst used in step a., problems relating to use of one-phase process, such as cracking and poor i-paraffin:n-paraffin ratio, can be avoided. Thus, the method is particularly useful to obtain a diesel fuel composition suitable for improving properties of diesel fuels used in cold climate.

The present diesel fuel compositions can be mixed with fossil diesel fuel or renewable diesel fuel in a desired amount, depending on the desired properties of the fossil fuel or renewable diesel fuel. E.g. when the blend comprises diesel fuel with low cetane number, a higher proportion of the diesel fuel composition can be used to raise the cetane number of the blend. Correspondingly, if cold properties of the fossil fuel are to be improved, a fuel component can be used which has a higher i-paraffin/n-paraffin ratio, as defined below.

The cetane number increase achieved by the disclosed methods and diesel fuel compositions was synergistic and much higher compared to the effect obtainable by using other fuel components, such as GTL. Without binding to any theory, the observed synergistic effect is caused by the manufacturing process of the diesel fuel component and the characteristics of the hydrotreated renewable fuel component and the cetane number improver. The synergistic effect was confirmed experimentally when the inventors used renewable fuel component having similar carbon number distribution as HVO. This finding was successfully used by the inventors to define a diesel fuel composition comprising a hydrotreated renewable fuel component, fossil fuel, and a cetane number improver.

The present diesel fuel compositions are also advantageous in having high density, viscosity and lubricity.

### BRIEF DESCRIPTION OF THE FIGURES

FIG. 1 shows the profile of paraffinic components for renewable fuel (RN2 and RN2) and GTL fuels. CP refers to cloud point.

FIG. 2 shows the effect of different amounts of 2-EHN addition in GTL and renewable fuel (RN2) fuel blends.

FIG. 3 shows graphically the cetane number improvement in a renewable fuel (RN) and fossil fuel blend compared to a fossil diesel fuel.

FIG. 4 shows graphically the cetane number improvement in a renewable fuel (RN) and fossil fuel blend compared to a fossil diesel fuel.

FIG. 5 shows a detailed distribution of paraffinic components in renewable fuel (RN2) and GTL fuels.

### DETAILED DESCRIPTION

In an exemplary embodiment the present renewable raw material comprises vegetable oil, wood and/or other plant based oil, animal fat, fish fat and/or fish oil, algae oil, microbial oil, fats contained in plants bred by means of gene manipulation, recyclable waste, recyclable residue, or a combination thereof.

In an exemplary embodiment the present renewable raw material comprises rapeseed oil, colza oil, canola oil, tall oil, sunflower oil, soybean oil, hempseed oil, olive oil, linseed oil, mustard oil, palm oil, peanut oil, castor oil, coconut oil, lard, tallow, train, fats contained in milk, or a combination thereof.

In an exemplary embodiment the present cetane number improver is 2-EHN.

In an exemplary embodiment of the hydrotreated renewable fuel component, the amount of the paraffinic component in the range of carbon number C₁₅-C₁₈ is at least 70 wt-%, more preferably more than 80 wt-%, most preferably more than 90 wt-%. Such carbon number distribution is a characteristic of the present renewable fuel component showing synergistic cetane number improvement with 2-EHN.

In an exemplary embodiment the i-paraffin/n-paraffin ratio of the hydrotreated renewable component is at least 2.2 w/w, at least 2.3 w/w, at least 3 w/w or at least 4 w/w.

In an exemplary embodiment the renewable raw material is fed into the hydrotreatment step a. in a feed comprising less than 10 w-ppm alkaline metals and alkaline earth metals calculated as elemental alkaline metals and elemental alkaline earth metals, less than 10 w-ppm other metals calculated as elemental metals, and less than 30 w-ppm phosphorus calculated as phosphorus.

In an exemplary embodiment the feed comprises a fresh feed of the renewable raw material and a feed of a diluting agent, and wherein the diluting agent:fresh feed ratio is 10-30:1, preferably 12-25:1, and wherein the diluting agent is selected from hydrocarbons and recycled products of the process, or a mixture thereof.

In an exemplary embodiment in the hydrotreatment step pressure is selected from, or varies in, the range 2-15 MPa, preferably 3-10 MPa, and the temperature is selected from, or varies in, the range 200-500° C., preferably 280-400° C.

In an exemplary embodiment the hydrotreatment step is carried out in the presence of a hydrotreatment catalyst, which contains a metal from the Group VIII and/or Group VIB of the Periodic System.

In an exemplary embodiment the hydrotreatment catalyst is supported Pd, Pt, Ni, NiMo or CoMo catalyst and the support is alumina and/or silica.

In another exemplary embodiment the isomerisation catalyst contains a molecular sieve.

In another exemplary embodiment the isomerisation catalyst contains Al₂O₃ or SiO₂.

In another exemplary embodiment the isomerisation catalyst contains SAPO-11 or SAPO-41 or ZSM-22 or ZSM-23 or ferrierite; and Pt or Pd; and Al₂O₃ or SiO₂.

In an exemplary embodiment the cetane number improver is added to the hydrotreated renewable fuel component obtained in step b.

In an exemplary embodiment steps a. and b. are carried out repeatedly by feeding product recycle from step b. into step a. until a desired degree of hydration and isomerisation of the renewable raw material is obtained.

In an exemplary embodiment of the diesel fuel composition, the hydrotreated renewable fuel component contains at least 70 wt-% of the paraffinic component having a carbon number in the range of C₁₅-C₁₈ and the i-paraffin/n-paraffin ratio of the hydrotreated renewable component is at least 2.2 w/w, at least 3 w/w or at least 4 w/w.

In an exemplary embodiment the diesel fuel composition has a cloud point of at least −10° C.

In an exemplary embodiment the cetane number improver in the diesel fuel composition is 2-EHN.

In an exemplary embodiment the content of the hydrotreated renewable fuel component in the diesel fuel composition is in the range of 5-90 vol-%, more preferably in the range of 20-80 vol-%. This amount is advantageous because it reduces harmful effects of 2-EHN while raising the cetane number of the blend to a desired level.

In another exemplary embodiment the amount of the cetane number improver used in the diesel fuel composition is less than 500 mg/kg, such as about 450, 400, 350, 300, 350, 300, 250, 200, 150, or 100 mg/kg. In an exemplary embodiment the amount is selected to be within the range 100-450 mg/kg, 100-400 mg/kg or 100-300 mg/kg.

In an exemplary embodiment the cetane number improver in the diesel fuel composition is 2-EHN, and the amount of 2-EHN is below 2000 mg/kg, and more preferably selected from the range of 100-1000 mg/kg, most preferably from the range 100-400 mg/kg.

2-ethyl hexyl nitrate (2-EHN) is a cetane number improver, which can be used to improve, i.e. increase, the cetane number of fuels, such as diesel fuels.

GTL is a Fischer-Tropsch derived fuel having a similar cloud point than a fuel derived from HVO. GTL is characterized by broad distribution of paraffinic hydrocarbons in the range C₉-C₂₄. GTL has typically a cetane number in the range 73-81 (Aatola et al. Hydrotreated Vegetable Oil (HVO) as a Renewable Diesel Fuel: Trade-off between NOx, Particulate Emission, and Fuel Consumption of a Heavy Duty Engine, SAE International 2008-01-2500).

The inventors surprisingly found that even though HVO and GTL as such have similar properties with regard to cetane number, cloud point, and density, when used in blends comprising either HVO or GTL, a fossil fuel component, and a cetane number improver, a significantly different effect on the cetane number is achieved. A smaller addition of the cetane number improver in a HVO containing fuel blend is sufficient to increase the cetane number of the fuel blend to a level obtained in a GTL containing fuel blend only with a much higher cetane number improver addition. Consequently, by using HVO in the blend a much smaller cetane number improver addition is needed, reducing consumption and its harmful effects.

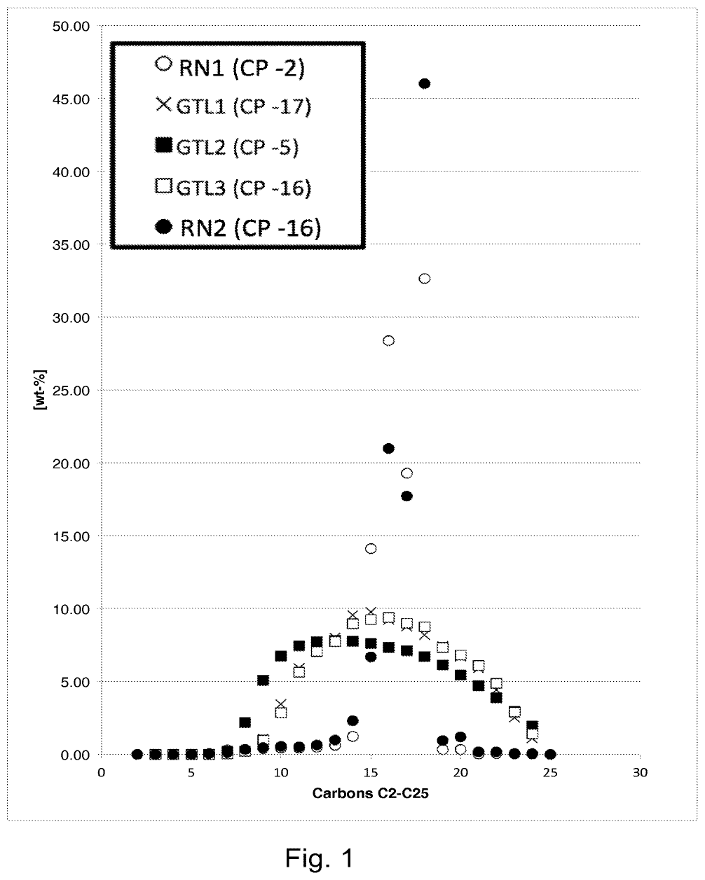

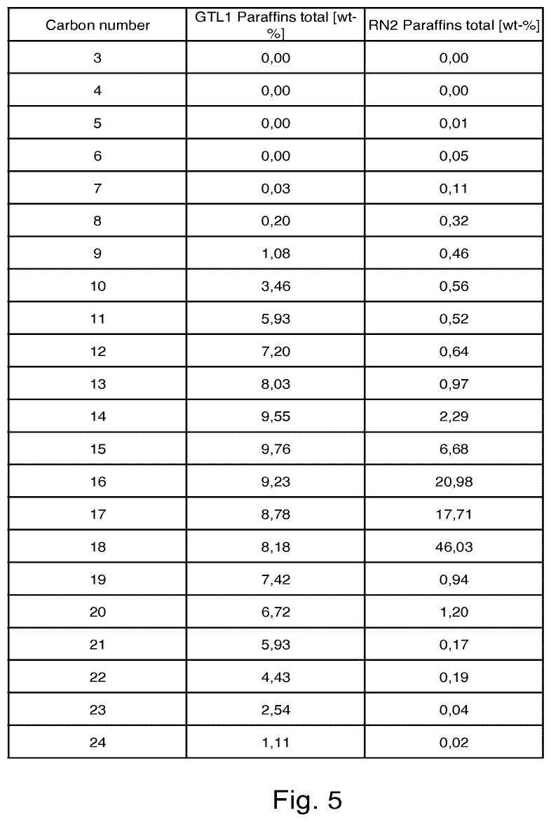

The GTL and HVO components were analysed in more detail in Example 1. The analysis revealed significant differences in the carbon number profiles of these two fuel components. As evidenced by the Examples and shown in FIGS. 1 and 5, the total paraffin distributions of these components are markedly different, resulting into different properties. Without binding to any theory, the results indicate that the characteristic paraffin profile of HVO component provides a synergistic effect with 2-EHN on the cetane number in fuel blends.

In an exemplary embodiment the biological raw material comprises vegetable oil, animal fat, fish fat, fish oil, algae oil, microbial oil and/or wood and/or other plant based oil as well as recyclable waste and/or residue, or a combination thereof. In an exemplary embodiment the hydrotreated renewable fuel component obtained after hydrotreatment and isomerisation comprises HVO, or consists of HVO. Hydrotreating can be used for producing bio based middle distillate fuels. HVO fuels are sometimes referred to as “renewable fuels” instead of “bio-diesel” which is a term reserved for the fatty acid methyl esters (FAME). Chemically hydrotreated vegetable oils are mixtures of paraffinic hydrocarbons and have a very low quantity of sulphur and aromatics.

The diesel fuel compositions can be manufactured using a two-step process comprising hydrogenation followed by isomerisation. If a manufacturing process is used using a one-step process in which the hydrogenation and isomerisation steps are not carried in separate steps, harmful cracking may occur which results in a loss of long chain hydrocarbons and a change of carbon number profile towards shorter carbon numbers. One-step hydrogenation and isomerisation may also result in inferior i-paraffin:n-paraffin ratios compared to a two-step process where these steps are carried out sequentially. In an exemplary embodiment the two-step process is carried out by hydrogenating into n-paraffins followed by catalytic isomerisation into i-paraffins. Such a two-step process is described in FI1002488.

In an exemplary embodiment the amount of i-paraffins in the hydrotreated renewable fuel component is increased compared to the amount of i-paraffins after hydrogenation and before isomerisation. In another exemplary embodiment the carbon number distribution does not change, or does not substantially change, during isomerisation. In an exemplary embodiment the amount of paraffins in the carbon number range C₃-C₁₄ does not substantially increase during isomerisation. In an exemplary embodiment the hydrotreated renewable fuel component has a cloud point of at least −10° C. Such a cloud point is particularly useful for fuels intended for use in cold environment, such as winter grade diesel fuel. In an embodiment the cloud point is about −11, −12, −13, −14, −15, −16, −17, −18, −19, −20, −21, −22, −23, −24, −25, −26, −27, −28, −29 or −30° C.

In an exemplary embodiment the i-paraffin/n-paraffin ratio of the hydrotreated renewable component is at least 2.2 w/w, such as about 2.2, 2.3, 2.4, 2.5, 2.6, 2.7, 2.8, 2.9, 3, 4, 5, 6, 7, 8, 9 or 10.

The fossil fuel component means a component or composition, which is naturally occurring and derived from non-renewable sources. Examples of such non-renewable resources include petroleum oil/gas, shale oil/gas, natural gas or coal deposits, and the like, and combinations thereof, including any hydrocarbon-rich deposits that can be utilized from ground/underground sources. The term fossil also refers to recycling material of non-renewable sources.

In an exemplary embodiment the fossil fuel component is fossil middle distillate, such as fossil diesel. Diesel fuel in general is any liquid fuel suitable for use in diesel engines, where fuel ignition takes place without spark as a result of compression of the inlet air mixture and then injection of fuel. In an exemplary embodiment the diesel fuel is fossil diesel. The most common type of diesel fuel is a specific fractional distillate of fossil fuel, such as petroleum fuel oil. Distillation characteristics define how fuel is evaporated when it is sprayed into the combustion chamber of a diesel engine. Standards (e.g. EN590:2013 (5.5.2)) includes information about typical distillation curves.

To distinguish from alternative diesel fuels not derived from petroleum, petroleum-derived diesel is called herein as fossil diesel. It may also be called as e.g. petrodiesel, mineral diesel or petroleum distillate. Fossil diesel can comprise atmospheric or vacuum distillates. The distillate can comprise cracked gas oil or a blend of any proportion of straight run or thermally or catalytically cracked distillates. The distillate fuel can be subjected to further processing such hydrogen-treatment or other processes to improve fuel properties. Typically fossil diesel comprise naphthenics 10-50 weight %, monoaromatics 5-30 weight %, other polyaromatics 0-8 weight % and paraffins 10-50 weight %.

In an exemplary embodiment the hydrotreated renewable fuel component in the diesel fuel composition comprises or consists of hydrotreated vegetable oil, hydrotreated animal fat, hydrotreated fish fat, hydrotreated fish oil, hydrotreated algae oil, hydrotreated microbial oil, hydrotreated wood and/or other plant based oil, hydrotreated recyclable waste and/or residue or a combination thereof. An advantage of this exemplary embodiment is that when said materials are used in hydrotreating, a renewable fuel component is obtained which together with a cetane number improver is able to synergistically increase cetane number of fuel compositions comprising fossil fuel component. Additionally carbon residue increase can be minimized.

In an exemplary embodiment the cetane number improver comprises or consists of 2-EHN. 2-EHN is particularly useful to increase cetane number of a blend comprising a hydrotreated renewable fuel component, such as HVO, and a fossil fuel component.

In an exemplary embodiment the amount of the paraffinic components in the hydrotreated renewable fuel component that have a carbon number range of C₁₅-C₁₈ is at least 70 wt-%, more than 80 wt-%, or more than 90 wt-%. When a hydrotreated renewable fuel component having said paraffinic component profile is used to together with 2-EHN, the cetane number of the fuel composition increases.

In an exemplary embodiment the amount of paraffinic components in the hydrotreated renewable fuel component that have a carbon number range of C₃-C₁₄ is less than 25 wt-%, less than 20 wt-%, less than 10% wt-%, or less than 7 wt-%. Optionally in the hydrotreated renewable fuel component the amount of the paraffinic components that have a carbon number range of C₁₉-C₂₄ is less than 25 wt-%, less than 20 wt-%, less than 10 wt-%, or less than 5 wt-%.

In an exemplary embodiment the hydrotreated renewable component has a cetane number of at least 70, or at least 80. By using a hydrotreated renewable component having high cetane number, a smaller addition of hydrotreated renewable component and a cetane number improver provides a desired increase in a blend comprising a fossil fuel component.

In an embodiment the hydrotreated renewable fuel component comprises hydrotreated vegetable oil, hydrotreated wood and/or other plant based oil, hydrotreated animal fat, hydrotreated fish fat and oil, hydrotreated algae oil, hydrotreated microbial oil, hydrotreated recyclable waste, hydrotreated recyclable residue, or a combination thereof.

In an exemplary embodiment the content of the hydrotreated renewable fuel component in the diesel fuel composition is in the range of 5-90 vol-%, or in the range of 20-80 vol-%. In an embodiment the content of the hydrotreated renewable fuel component in the diesel fuel composition is 20, 25, 30, 35, 40, 45, 50, 55, 60, 65, 70, 75 or 80 vol-%.

In an exemplary embodiment the diesel fuel composition is a fuel composition obtainable by blending the diesel fuel component with fossil diesel fuel.

In an exemplary embodiment the diesel fuel component does not contain fatty acid methyl esters. The final diesel fuel composition may contain further refinery and performance components such as lubricity, cold flow, antistatic and detergent components.

### EXAMPLES

The following examples are provided to illustrate various aspects of the present disclosure. They are not intended to limit the disclosure, which is defined by the accompanying claims.

### Example 1: Carbon Number Profile of a Renewable Fuel and GTL

Carbon number profiles of HVO as a renewable fuel and GTL were analysed by gas chromatography (GC). The results are shown in FIG. 1 and FIG. 5.

### Example 2: Analysis of a Renewable Fuel and GTL

Physical properties of HVO as a renewable fuel and GTL samples were analysed. The results are shown in table 1. The analysis reveals marked differences in important parameters of these fuels.

TABLE 1
Analysis of HVO and GTL components. Starting point of distillation
(Initial boiling point), end point of distillation (95 vol-% recovered at).

| | | | GTL3 | RN2 |
|---|---|---|---|---|
| ENISO12185:1996 | Density | kg/m3 | 764.9 | 781.1 |
| ASTMD7689: 2012 | Cloud point | ° C. | −16.3 | −16.1 |
| EN15195: 2014 | Cetane Number | | 77.8 | 85.1 |
| ENISO3405: 2012 | Initial boiling | ° C. | 162.8 | 227.6 |
| | point | | | |
| ENISO3405: 2012 | 95 vol-% | ° C. | 320 | 298.7 |
| | recovered at | | | |

### Example 3

Two diesel blends were prepared with base cetane level of about 42. One contained renewable paraffinic diesel and the second one not. Three 2-EHN levels were tested on these blends. Cetane numbers are presented in table 2. Corresponding fuels with base cetane level of about 48 were prepared and cetane responses of 2-EHN measured accordingly (Results in table 3)

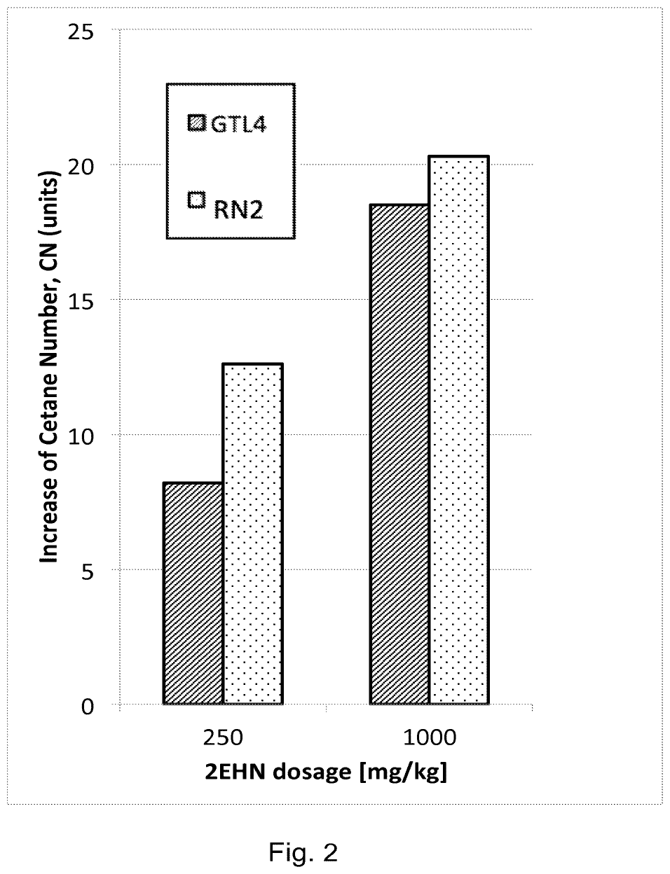

Increase of cetane number of a composition comprising GTL or renewable fuel, and 2-EHN was analysed using two 2-EHN dosages. The results are illustrated in FIG. 2 showing greater increase of the cetane number in blends comprising renewable fuel compared to blends comprising GTL. 2-EHN is also shown to increase cetane number at different 2-EHN levels.

TABLE 2
Cetane responses with various 2-EHN dosing rates, base diesel
cetane number ~42.

| | Fossil fuel | | | |
|---|---|---|---|---|
| | component | | Fossil | |
| 2-EHN | 70% + | Cetane | diesel 1, | Cetane |
| dosage, | RN 30%, | Number | Cetane | Number |
| [mg/kg] | Cetane Number | improvement | Number | improvement |
| 0 | 42.9 | — | 42.2 | — |
| 200 | 45.9 | 3 | 44.2 | 2 |
| 500 | 47.6 | 4.7 | 46.1 | 3.9 |
| 1000 | 49.1 | 6.2 | 47.8 | 5.6 |

TABLE 3
Cetane responses with various 2-EHN dosing rates, base diesel cetane
number ~48

| | Fossil fuel | | Fossil | |
|---|---|---|---|---|
| 2-EHN | component | Cetane | diesel 2, | Cetane |
| dosage, | 60% + | Number | Cetane | Number |
| [mg/kg] | RN 40% | improvement | Number | improvement |
| 0 | 48.1 | — | 48.6 | — |
| 200 | 50.6 | 2.5 | 50.5 | 1.9 |
| 500 | 52.3 | 4.2 | 51.8 | 3.2 |
| 1000 | 53.6 | 5.5 | 53.2 | 4.6 |

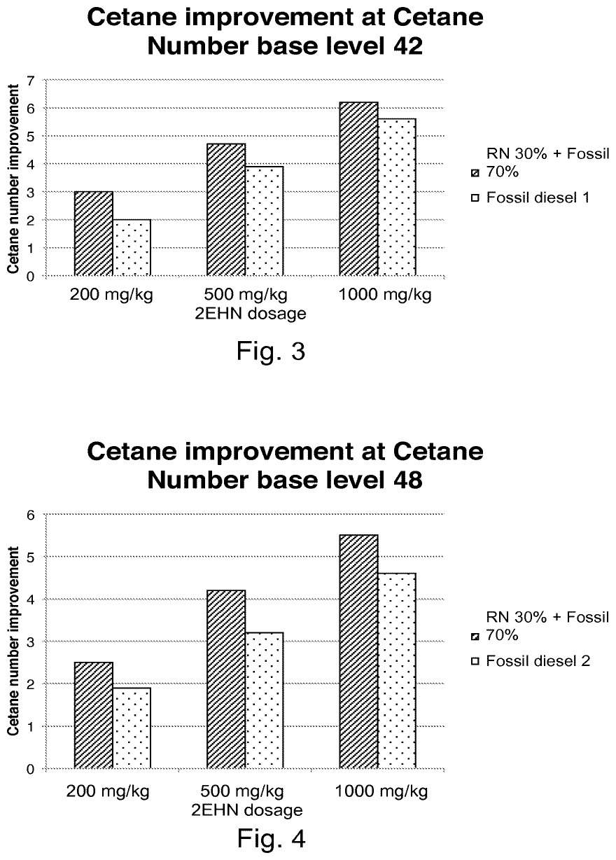

In all cases, the fuels containing renewable paraffinic diesel showed greater cetane response of 2-EHN. Results are depicted in FIGS. 3 and 4.

As a conclusion lower dosing of cetane number improver is required in fuels containing renewable paraffinic diesel in order to meet cetane number target. In addition to meeting cetane number requirements in EN590:2013 (5.5.2) and ASTM D975 2017, it is beneficial in producing premium diesel grades with higher cetane number.

The foregoing description has provided by way of non-limiting examples of particular implementations and embodiments of the disclosure a full and informative description of the best mode presently contemplated by the inventors for carrying out the disclosed methods and diesel fuel compositions. It is however clear to a person skilled in the art that the disclosure is not restricted to details of the embodiments presented above, but that it can be implemented in other embodiments using equivalent means without deviating from the characteristics of the disclosed methods and diesel fuel compositions.

Furthermore, some of the features of the above-disclosed embodiments of this disclosure may be used to advantage without the corresponding use of other features. As such, the foregoing description should be considered as merely illustrative of the principles of the disclosed methods and diesel fuel compositions, and not in limitation thereof.

1. A diesel fuel composition comprising:
a hydrotreated renewable fuel component;
a fossil fuel component; and
a cetane number improver,
wherein the fossil fuel component is a fossil middle distillate, and
wherein the hydrotreated renewable fuel component constitutes 5-90 vol-% of the diesel fuel composition.

2. The diesel fuel composition of claim 1, wherein the hydrotreated renewable fuel component contains at least 80 wt-% of C₁₅-C₁₈ paraffins.

3. The diesel fuel composition of claim 1, wherein the cetane number improver is 2-ethylhexyl nitrate (2-EHN).

4. The diesel fuel composition of claim 3, wherein 2-EHN is present in the diesel fuel composition in an amount ranging from 100-1000 mg/kg.

5. The diesel fuel composition of claim 1, wherein the hydrotreated renewable fuel component is present in the diesel fuel composition in a range of 20-80 vol-%.

6. The diesel fuel composition of claim 1, wherein the hydrotreated renewable fuel component is present in the diesel fuel composition in a range of 20-80 vol-%, and the fossil fuel component is present in the diesel fuel composition in a range of 80-20 vol-%.

7. The diesel fuel composition of claim 1, wherein the hydrotreated renewable fuel component contains hydrotreated vegetable oil (HVO), hydrotreated animal fat, hydrotreated fish fat, hydrotreated fish oil, hydrotreated algae oil, hydrotreated microbial oil, hydrotreated wood and/or other plant based oil, hydrotreated recyclable waste and/or residue, or a combination thereof.

8. The diesel fuel composition of claim 1, wherein the hydrotreated renewable fuel component contains at least 90 wt-% of C₁₅-C₁₈ paraffins.

9. The diesel fuel composition of claim 1, wherein the fossil fuel component is a fossil diesel comprising:
atmospheric or vacuum distillates.

10. The diesel fuel composition of claim 9, wherein the atmospheric or vacuum distillates comprise:
cracked gas oil or a blend of any proportion of straight run or thermally or catalytically cracked distillates.

11. The diesel fuel composition of claim 9, wherein the fossil diesel comprises:
10-50 weight % naphthenics, 5-30 weight % monoaromatics, 0-8 weight % other polyaromatics, and 10-50 weight % paraffins.

12. A method for improving a diesel fuel composition's cold properties, the method comprising:
catalytically hydrotreating a renewable raw material comprising fatty acids, triglycerides, fatty acid esters, or combinations thereof into n-paraffins;
catalytically isomerising the n-paraffins into branched chain paraffins to obtain a hydrotreated renewable fuel component; and
mixing a cetane number improver and a fossil fuel component with the hydrotreated renewable fuel component,
wherein the hydrotreated renewable fuel component produced from the catalytic isomerization contains an i-paraffin/n-paraffin ratio of at least 2.2 w/w.

13. The method of claim 12, wherein the hydrotreated renewable fuel component contains at least 80 wt-% of C₁₅-C₁₈ paraffins.

14. The method of claim 12, wherein the renewable raw material has less than 10 w-ppm of alkaline metals and alkaline earth metals calculated as elemental alkaline metals and elemental alkaline earth metals, less than 10 w-ppm of other metals calculated as elemental metals, and less than 30 w-ppm of phosphorus calculated as phosphorus.

15. The method of claim 12, wherein the cetane number improver is 2-ethylhexyl nitrate (2-EHN).

16. The method of claim 12, wherein the hydrotreated renewable fuel component produced from the catalytic isomerization contains an i-paraffin/n-paraffin ratio of at least 3 w/w.

17. The method of claim 12, wherein the diesel fuel produced from the method has a cloud point of at least −10° C.

18. The method of claim 12, wherein the catalytic hydrotreating of the renewable raw material occurs in a presence of a hydrotreatment catalyst.

19. The method of claim 18, wherein the catalytic isomerization occurs in an absence of the hydrotreatment catalyst used in the catalytic hydrotreating of the renewable raw material.

20. The method of claim 18, wherein the hydrotreatment catalyst comprises:
Pd, Pt, Ni, NiMo or CoMo supported on alumina and/or silica.
